(19) United States
(12) Patent Application Publication
(10) Pub. No.: US 2022/0327639 A1
(43) Pub. Date: Oct. 13, 2022

(54) Method and System for Reducing Bias in Matching

(71) Applicants: Laura Ashley Ciccone, Los Angeles, CA (US); Taly Georgia Matiteyahu, Los Angeles, CA (US)

(72) Inventors: Laura Ashley Ciccone, Los Angeles, CA (US); Taly Georgia Matiteyahu, Los Angeles, CA (US)

(73) Assignee: Blink Date Inc., Los Angeles, CA (US)

(21) Appl. No.: 17/716,611

(22) Filed: Apr. 8, 2022

Related U.S. Application Data
(60) Provisional application No. 63/172,652, filed on Apr. 8, 2021.

(51) Int. Cl. G06Q 50/00; H04L 51/52

(52) U.S. Cl. CPC G06Q 50/01; H04L 51/52

(57) ABSTRACT

Methods and systems for reducing superficial judgment in peer-to-peer matching. In one method, a system matches members with one another without the initial influence of physical appearance or a dating profile. When the members both say “Yes” or “Maybe” to each other after their audio-only speed date, they then move on to rating a group of anonymized photos based on the gender and age parameters on based on their profile. The system may randomize photos, and it will always include a photo of the individual the member had their audio date with. If both members provide a positive approval of the photo the individual the member had their audio date with, the members are connected to permit further communication.

### CROSS-REFERENCE TO RELATED APPLICATIONS

This application claims the benefit of U.S. Provisional Application Ser. No. 63/172,652, filed on Apr. 8, 2021, the entire disclosure which is incorporated by reference in its entirety.

### FIELD

The subject matter disclosed herein generally relates to methods and systems for reducing superficial judgment in peer-to-peer matching.

### BACKGROUND

Traditional mobile dating applications and websites typically use methods to match users based on user-generated profile pages, swiping algorithms, and the popularity of profiles, which then match and send users through to a messaging platform if there is mutual interest. Several issues arise with this process: (1) users are potentially swiping away compatible matches as their decisions are based on superficial impressions based on user-generated profiles, (2) users match and engage in messaging but ultimately do not make a connection, and (3) users' connection may appear strong during online messaging, but within a few minutes of having an audio-format conversation, it is clear there is no actual chemistry.

### SUMMARY

Methods and systems for reducing superficial judgment in peer-to-peer matching are disclosed herein. In one method for reducing bias in a matching process, the method comprises electronically receiving a plurality of user online-dating profiles, in which each profile comprising a user photograph, gender, and age range as well as user preferences for a prospective match. The method comprises electronically receiving one or more date and times a first user is available for an online, audio date. The method comprises determining at least one potential match from the plurality of user online-dating profiles for the first user in response to the availability of the first user and a second user. The method comprises causing the online, audio date between the first user and the second user. The method comprises electronically receiving a date rating from the first user and a date rating from the second user. The method comprises determining whether each of the first and second user provided a non-negative date rating. The method comprises in response to determining non-negative date ratings from the first user, presenting at least two images purported to be the second user to the first user, wherein at least one image presented to the first user is an image provided by the second user. The method further comprises in response to determining non-negative date ratings from the second user, presenting at least two images purported to be the first user to the second user, wherein at least one image presented to the second user is an image provided by the first user. The method comprises electronically receiving ratings from the first user for each of the images for the second user, and electronically receiving a rating from the second user for each of the images for the first user. The method further comprises determining whether the first user provided a non-negative rating when viewing at least one image provided by the second user, and determining whether the second user provided a non-negative rating when viewing the at least one image provided by the first user. The method further comprises enabling communication between the first user and the second user in response to determining both the first user has provided a non-negative rating to at least one image provided by the second user and the second user has provided a non-negative rating to at least one image provided by the first user. The method further comprises prohibiting communication between the first user and the second user in response to determining either the first user has provided a negative rating to at least one image provided by the second user or the second user has provided a negative rating to at least one image provided by the first user.

In another aspect, a non-transitory computer-readable medium comprising instructions that, when executed by a processor, are configured to: electronically receive a plurality of user online-dating profiles, each profile comprising a user photograph, gender, and age range as well as user preferences for a prospective match; electronically receive one or more date and times a first user is available for an online, audio date; determine at least one potential match from the plurality of user online-dating profiles for the first user in response to the availability of the first user and a second user; cause the online, audio date between the first user and the second user; electronically receive a date rating from the first user and a date rating from the second user; determine whether each of the first and second user provided a non-negative date rating; in response to the determination that non-negative date ratings from the first user, presenting at least two of images purported to be the second user to the first user, wherein at least one image presented to the first user is an image provided by the second user; in response to the determination that non-negative date ratings from the second user, presenting at least two images purported to be the first user to the second user, wherein at least one image presented to the second user is an image provided by the first user; electronically receive ratings from the first user for each of the images the second user, and electronically receive rating from the second user for each of the images from the first user; determine whether the first user provided a non-negative rating when viewing the at least one image provided by the second user, and determine whether the second user provided a non-negative rating when viewing the at least one image provided by the first user; in response to the determination that both the first user has provided a non-negative rating to at least one image provided by the second user and the second user has provided a non-negative rating to the at least one image provided by the first user, enabling communication between the first user and the second user; and in response to the determination that either the first user has provided a negative rating to at least one image provided by the second user or the second user has provided a negative rating to the at least one image provided by the first user, prohibiting communication between the first user and the second user.

### BRIEF DESCRIPTION OF DRAWINGS

FIG. 1 is a block diagram of one embodiment of a system for reducing superficial judgment in peer-to-peer matching;

FIG. 2 is a block diagram of one embodiment of a matching system; and

FIG. 3 is an exemplary flow diagram for peer-to-peer matching.

### DETAILED DESCRIPTION

Briefly, and in general terms, various systems and related methods are directed to reducing superficial judgment in peer-to-peer matching. According to one embodiment, the system utilizes mobile devices, and may include browser-based devices, which matches members with one another without the initial influence of physical appearance or a dating profile. In the present invention, when the members both say “Yes” or “Maybe” to each other after their audio-only speed date, (the “Blink Date”), they then move on to rating a group of anonymized photos (the “Glances Module”) based on the gender and age parameters on their profile (in the “Member Profile Store”). The system may randomize photos, and it will always include a photo of the individual the member had their Blink Date with, which is the method that reduces superficial judgment.

By allowing members to speak with each other on audio-only blind speed dates as their initial interaction (Blink Dates 224), members are able to save time by avoiding these issues. Furthermore, when members talk with each other before seeing photos, they are more likely to say “Yes” or “Maybe” on photos they may have swiped “No” to on traditional dating mobile applications and websites as described.

A system and method are described for enabling members using their mobile devices to connect with each other for Blink Dates 224. In some embodiments, a member can transmit a request for a date given their preferences and location. A service may handle the request by selecting a party that matches their preferences in the Date Scheduling Module 220. According to some embodiments, the pairing of the members to each other is performed programmatically and/or automatically, based on parameters such as the location of both members using both the Date Scheduling Module 220 and the Member Matching Module 222.

Additionally, some embodiments provide that the members may have an upcoming date, who in turn have the ability to cancel their date. In some embodiments, when one party cancels, the system will receive this request and set the other member up with another party that matches their preferences in the Date Scheduling Module 220 and the Date Matching Module 222.

According to embodiments, members who are matched will enter into the Blink Date Module 226. After the meeting, some embodiments may allow the members to rate the date and take notes, among other actions, in the Speed Date Rating (“Evalu-Date”) Module 226.

According to the embodiments, if a member marks “Yes” or “Maybe” after the Evalu-Date, they will enter the Glances Module 228. This embodiment may use the system to ping the server to source and present the member with a randomized group of photos matching their Member Profile Store 200 from the Member Photo Store 202, and it may minimally contain the photo of the member with whom they just spoke in addition to at least one other member photo. Some embodiments may show stock photos when there are not enough matching member photos in the Member Photo Store 202. While this embodiment may store ratings for the additional randomized photos in the Photo Feedback Store 210, the member rating on the photo during the Glance Module may only have an actual impact on the matching with the individual with whom they just had a Blink Date. Some embodiments may require the randomized photos to not re-appear for a set period of time that is determined by the system or system operator The randomized photos may be tagged or otherwise labeled so that it will not be shown again to an individual in order to minimize the possibility that the individual recognizes the photo from prior Blink Dates.

Among other features, at least some embodiments provide that the compatibility of the respective parties is determined programmatically using a matching algorithm. This information is communicated to each party without the need for manual involvement by the parties operating the mobile device (e.g. when the member makes the request for dates, the system cross-checks the Member Profile Store 200 and automatically includes relevant matches in the request).

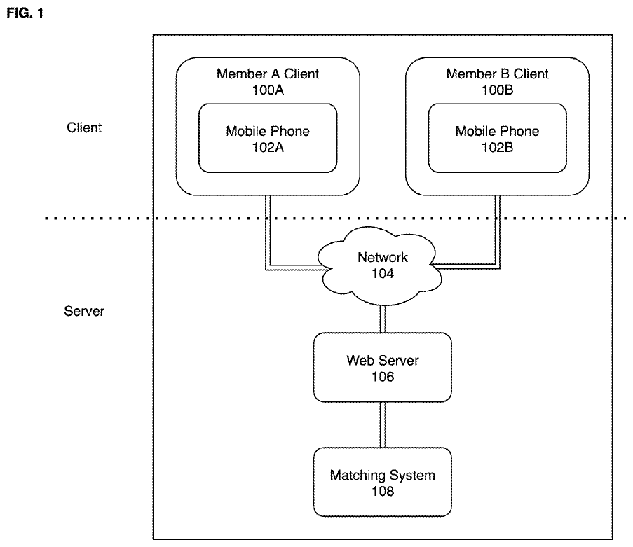

Referring to FIG. 1, the embodiment of a block diagram of components that facilitate mobile users to interact with servers to be matched with and connected to each other is shown. Members 100A and 100B interface with their respective mobile devices 102A and 102B, which connects them to a network 104. The network 104 then communicates with the webserver 106. The web server then facilitates the passing of information to the matching system 108.

The mobile devices 102A and 102B may be a cellular phone, a laptop, tablet computer, personal data assistant (PDA), or other suitable portable computing device that is wireless or otherwise can access the Internet or perform web browsing functions, or access and communicate with the network 104. The mobile devices 102A and 102B includes a user interface such as, but not limited to, a touch screen display that presents information to the user and may also simulate a keyboard, mouse, or trackpad that permits user input. The mobile devices 102A and 102B may also include a video camera, microphone, and speakers.

The network 104 is a communicative platform operable to exchange data or information from the mobile devices 102A and 102B. The network 104 may be any packet data network offering a communications interface or exchange between any two nodes in a system. The network 104 may be any local area network (LAN), wide area network (WAN), wireless local area network (WLAN), virtual private network (VPN), intranet, or any other architecture or system that facilitates communications in a network or telephonic environment. The network connections may be wired or wireless mediums provisioned with routers and firewalls.

A mobile application operable on the mobile devices 102A and 102B. The mobile application allows users to create a member account and upload at least one photo during the registration process. The mobile application may use the camera resident on the mobile device 102A and 102B to capture a user image or access the camera roll (i.e., photograph database on the mobile device) to allow the user to select a photo to add to the member profile. The mobile application may access the geolocation data on the mobile device to complete the user profile with respect to their location or the user may input their location (e.g., city/state or zip code). The mobile application also allows a user to enter information about themselves so they may be matched with others, which includes but is not limited to: age, gender, and location. Users may also input their matching or dating preferences, including but not limited to: age range, gender or genders, and geographic proximity. In one embodiment, the mobile application will also allow users to enter basic lifestyle questions which are shown to other members only after having spoken with each other. The information the user provided via the mobile application is transmitted and stored on a networked computer system (i.e., server).

The mobile application also allows users to enter their availability for a date. The mobile application provides the platform in which the audio-only dates are conducted between users. While waiting for the date to start, the mobile application may present a countdown timer, message prompts, or some other audio-visual interaction while waiting for the date to start such as but not limited to dating tips or dating advice.

The mobile application allows the user to access different functions on their mobile device 102A and 102B such as, but not limited to, a mute button or utilization of a speaker phone. Additionally, the mobile application includes the functionality to allow the user to end the date early by pushing a virtual button on the mobile application. The mobile application also provides access to an in-application chat function that allows connected users to communicate and share text messages, emoji, audio files, and audiovisual files. The chat function is enabled when the users mutually “match” after a date as set forth in the methods disclosed herein.

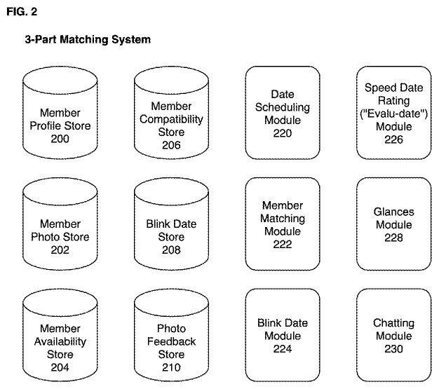

FIG. 2 is a block diagram illustrating the components of the present invention that make up the 3-Part Matching System. To facilitate pairing members, the system may collect and store information. Whenever a member inputs and updates their selected details and preferences, which includes, but is not limited to, their gender preferences and identification as well as geographic proximity, the Member Profile Store 200 may be updated. The user photo may be stored in the Member Photo Store 202. The user may select and upload photos from their social media accounts, camera roll, or take and upload a photo using the mobile application. The Member Photo Store 202 may additionally store stock photos with tagged demographics such as age range, which in some embodiments will appear to a member who does not have enough match photos. Member A Client 100A and Member B Client 100B may input their availability which may be stored in Member Availability Store 204. Based on the Member Profile Store 200 and Member Availability Store 204, potential matches may be scheduled and members may be notified of upcoming dates through the Date Schedule Module 220. The upcoming dates may be logged in the Member Compatibility Store 206. When the date is about to start, the Member Matching Module 222 may ensure all dates are online and sequenced. In the event either Member Client A 100A or Member Client B 100B are not connected to the Network 104, the system may check the Member Compatibility Store 206 for alternative matches for the scheduled date.

When both Member Client A 100A and Member Client B 100B have logged onto their mobile device, they may enter the Blink Date Module 224. After the Blink Date ends, Member Client A 100A and Member Client B 100B may enter the Speed Date Rating (“Evalu-date”) Module 226. Member Client A 100A and Member Client B 100B responses may be recorded in the Blink Date Store 208.

Should Member Client A 100A and Member Client B 100B indicate “Yes” or “Maybe” in the Evalu-Date Module 226, then they may enter the Glances Module 228. Member Client A 100A and Member Client B 100B responses from the Glances Module 228 may be recorded in the Photo Feedback Store 210. If either Member Client A 100A or Member Client B 100B indicate “No”, the Blink Date ends and the Member Clients session in the Evalu-Date Module is terminated. The Member Clients are then returned to the home page to wait for the next date, sign up for another date, or take any other permissible actions.

Should Member Client A 100A and Member Client B 100B indicate “Yes” or “Maybe” in the Glances Module 228, then Member Client A 100A and Member Client B 100B will enter the Chatting Module 230. If either Member Client A 100A or Member Client B 100B indicate “No”, the Blink Date ends and the Member Clients session in the Evalu-Date Module is terminated. In alternate embodiment, a Member Client may be given a second chance or a short period of time to change their inputted choice in the event, for example, the member has changed their mind or inadvertently inputted a rating (e.g., “No” instead of “Yes”).

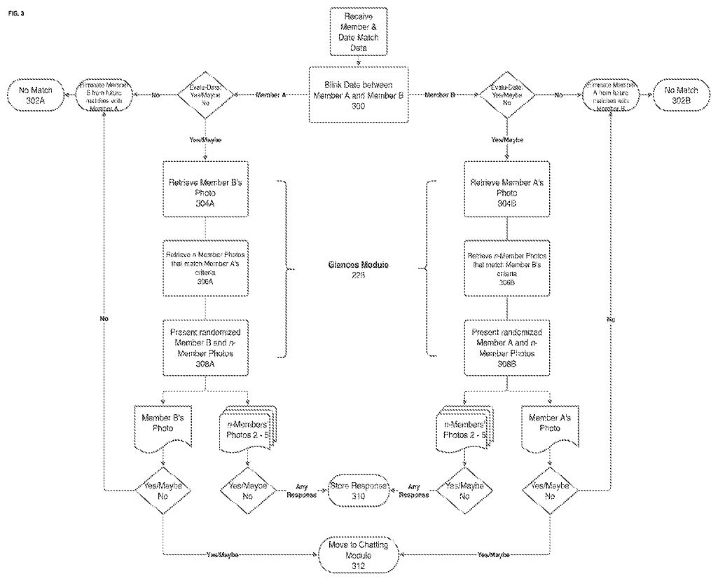

FIG. 3 is a flow diagram of a routine that enables members to establish compatibility with, meet, rate, and potentially match with each other. It specifically details what may occur within the Glances Module 228. The flow may start once the Matching System 108 has inputs for the Member Profile Store 200, the Member Photo Store 202, the Member Availability Store 204, and the Member Compatibility Store 206, and may commence once the Date Scheduling Module 220 and the Member Matching Module 222 is in a success state. This describes the system events leading up to the Blink Date between Member A and Member B 300.

At step 300, the Blink Date Module 224 initiates a Blink Date between Member A and Member B. As discussed previously, the Blink Date consists of an audio-only date between the members. In an alternate embodiment, the Blink Date is an audio-visual date in which the face of the individual is obscured. In this embodiment, the mobile device includes software to obscure the face of the individual so that facial features may not be visible. In another embodiment, the face of the individual is replaced with an avatar. In those embodiments with an audio-visual date, the visual component does not allow the members to actually see the other member. The Blink Date lasts a predetermined duration as established at the outset of the Blink Date by the Module 224. Alternatively, the duration of the Blink Date is an average of the durations of the date selected by the members. For example, if a member selects a 1-minute date and the other member selects a 2-minute date, the Module 224 establishes a 90-second date. In one exemplary method, at the completion of the Blink Date, each Member Client may enter notes about the date in their mobile application and this data is stored in the Blink Data Store 208. At steps 302A and 302B, when either Member Client A 100A and Member Client B 100B indicate “No,” the Members may be prevented from reappearing as a potential date for the other member and terminate at No Match. The Web Server 106 sends a termination message to the mobile devices for Member Client A and Member Client B.

When Member Client A 100A and Member Client B 100B indicate “Yes” or “Maybe” in the Evalu-Date Module 226, they enter the Glances Module 228. In the Glances Modules, each Member Client receives at least 2 photos on their mobile device of which one photo is a photo of the Member Client and one or more photos are randomly selected photos. At steps 304A and 304B, the system may first retrieve the corresponding Member Client's photo 304A and 304B in order to display Member Client B 100B's photo to Member Client A 100A, and vice versa. At steps 306A and 306B, the system may then retrieve randomized Member photos which match or are similar to the Member Client's demographic characteristics such as, but not limited to, gender identification (man, woman, nonbinary), age range, or age category (e.g., Boomers, Generation X, Millennials, and Generation, Z). In one exemplary method, Web Server 106 may retrieve one or more photos that match Member A's stated preferences from the Member Profile Store 200. In another method, the Web server 106 may retrieve one or more stock photos from the Member Photo Store 202 that match the Member Client's demographic characteristics. In yet another method, the Web server 106 selects photos first from the Member Profile Store and only selects photos designated as stock photos from the Member Photo Store if there are an insufficient number of matching photos belonging to a member's profile in the Member Profile Store to meet the required number of photos that will be presented to the other Member. In yet another method, the Web Server 106 randomly selects photos from either the Member Photo Store 202 to meet the required number of photos that will be presented to the other Member.

At steps 308A and 308B, the system presents the photos selected in steps 304A and 306A and steps 304B and 306B in a randomized order. In an alternate method, all the selected photos are presented to the Member substantially simultaneously, and the Member is presented with “Yes, No, Maybe” rating options for each of the presented photos. In yet another alternative method, the system randomly determines whether to present all the photos at once or in a randomized order.

At step 310, the system receives the member input and stores the input in the Photo Feedback Store 210. When the Member is presented with another Member's photo 304A/304B and marks it as “No,” the system prevents the rejected Member from reappearing with the other Member and a message or notification 302A/302B is sent to the Member to inform the Member that a match was not made. At step 312, when both of the Members mark the other Member's actual photo 304A/304B as “Yes” or “Maybe,” the system may advance the Members 312 to the Chatting Module 230.

One or more aspects or features of the subject matter described herein may be realized in digital electronic circuitry, integrated circuitry, specially designed ASICs, field programmable gate arrays (FPGAs) computer hardware, firmware, software, and/or combinations thereof. These various aspects or features may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which may also be referred to as programs, software, software applications, applications, components, or code, include machine instructions for a programmable processor, and may be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium may store such machine instructions non-transitorily, such as for example as would a non-transient solid-state memory or a magnetic hard drive or any equivalent storage medium. The machine-readable medium may alternatively or additionally store such machine instructions in a transient manner, such as for example, as would a processor cache or other random access memory associated with one or more physical processor cores.

To provide for interaction with a user, one or more aspects or features of the subject matter described herein may be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

Although an embodiment has been described with reference to specific example embodiments, it will be evident that various modifications and changes may be made to these embodiments without departing from the scope of the present disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

It is submitted with the understanding that it will not be used to interpret or limit the scope or meaning of the claims. In addition, in the foregoing Detailed Description, it can be seen that various features are grouped together in a single embodiment for the purpose of streamlining the disclosure. Although an embodiment has been described with reference to specific example embodiments, it will be evident that various modifications and changes may be made to these embodiments without departing from the scope of the present disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. The subject matter described herein may be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed:

1. A computer-implemented method for reducing bias in a matching process, the method comprising:
electronically receiving a plurality of user online-dating profiles, each profile comprising a user photograph, gender, and age range as well as user preferences for a prospective match;
electronically receiving one or more date and times a first user is available for an online, audio date;
determining at least one potential match from the plurality of user online-dating profiles for the time first user in response to the availability of the first user and a second user;
causing the online, audio date between the first user and the second user;
electronically receiving a date rating from the first user and a date rating from the second user;
determining whether each of the first and second user provided a non-negative date rating;
in response to determining non-negative date ratings from the first user, presenting at least two images purported to be the second user to the first user, wherein at least one image presented to the first user is an image provided by the second user;
in response to determining non-negative date ratings from the second user, presenting at least two images purported to be the first user to the second user, wherein at least one image presented to the second user is an image provided by the first user;
electronically receiving ratings from the first user for each of the images of the second user, and electronically receiving rating from the second user for each of the images of the first user;
determining whether the first user provided a non-negative rating when viewing the at least one image provided by the second user, and determining whether the second user provided a non-negative rating when viewing the at least one image provided by the first user;
in response to determining both the first user has provided a non-negative rating to the at least one image provided by the second user and the second user has provided a non-negative rating to the at least one image provided by the first user, enabling communication between the first user and the second user; and
in response to determining either the first user has provided a negative rating to the at least one image provided the second user or the second user has provided a negative rating to the at least one image provided by the first user, prohibiting communication between the first user and the second user.

2. The method of claim 1, wherein the at least two images further comprises one or more images taken from other user online-dating profiles or stock images taken from an online database.

3. A non-transitory computer-readable medium comprising instructions that, when executed by a processor, are configured to:
electronically receive a plurality of user online-dating profiles, each profile comprising a user photograph, gender, and age range as well as user preferences for a prospective match;
electronically receive one or more date and times a first user is available for an online, audio date;
determine at least one potential match from the plurality of user online-dating profiles for the first user in response to the availability of the first user and a second user;
cause the online, audio date between the first user and the second user;
electronically receive a date rating from the first user and a date rating from the second user;
determine whether each of the first and second user provided a non-negative date rating;
in response to the determination that non-negative date ratings from the first second user, presenting at least two of images purported to be the second user to the first user, wherein at least one image presented to the first user is an image provided by the second user,
in response to the determination that non-negative date ratings from the second user, presenting at least two images purported to be the first user to the second user, wherein at least one image presented to the second user is an image provided by the first user;
electronically receive ratings from the first user for each of the images of the second user, and electronically receive rating from the second user for each of the images off the first user;
determine whether the first user provided a non-negative rating when viewing the at least one image provided by the second user, and determine whether the second user provided a non-negative rating when viewing the at least one image provided by the first user;
in response to the determination that both the first user has provided a non-negative rating to the at least one image provided by the second user and the second user has provided a non-negative rating to the at least one image provided by the first user, enabling communication between the first user and the second user; and
in response to the determination that either the first user has provided a negative rating to the at least one image provided by the second user or the second user has provided a negative rating to the at least one image provided by the first user, prohibiting communication between the first user and the second user.

4. The medium of claim 3, wherein the at least two images further comprises one or more images taken from other user online-dating profiles or stock images taken from an online database.
